(19) United States
(12) Patent Application Publication
(10) Pub. No.: US 2021/0071452 A1
(43) Pub. Date: Mar. 11, 2021

(54) Compression Latch

(71) Applicant: Whitecap Industries, Inc., Piscataway, NJ (US)

(72) Inventors: Christopher E. Tomao, Robbinsville, NJ (US); Du Sing-Long, Taipei (TW)

(73) Assignee: Whitecap Industries, Inc., Piscataway, NJ (US)

(21) Appl. No.: 17/015,750

(22) Filed: Sep. 9, 2020

Related U.S. Application Data
(60) Provisional application No. 62/898,860, filed on Sep. 11, 2019.

(51) Int. Cl. E05C 5/04; F16H 25/20; E05C 3/04

(52) U.S. Cl. CPC E05C 5/04; E05C 2005/005; E05C 3/04; F16H 25/20

(57) ABSTRACT

A compression latch is provided, which comprises a compression latch body comprising a first side and a second side opposite the first side, a handle extending from the first side and rotatable in an x-y plane, a rod extending from the second side in a z direction, a latch pawl connected to the rod and linear actuator connected to the handle and the rod.

### CROSS-REFERENCE TO RELATED APPLICATIONS

The instant patent application claims priority to U.S. provisional application Ser. No. 62/898,860, the entire content of which is incorporated herein by reference.

### TECHNICAL FIELD

The present disclosure relates generally to compression latches, and in particular, compression latches that are used on vehicles such as boats to open, close, lock and unlock hatches and doors on cabinets, enclosures and compartments.

### BACKGROUND

Compression latches are used in a variety of applications, such as in securing cabinet and panel doors and hatches in a closed position. Compression latches typically include a shaft cam which is attached to a shaft and which is moved by a handle.

When used on boats, compression latches secure hatches and doors that cover openings in various compartments, cabinets and enclosures of the boat. The handle is typically D-shaped or T-shaped, and foldable between an extended position in which the handle can be grasped by a user to open a hatch or door to which the compression latch is assembled. As shown in FIGS. 1A and 1B of U.S. Pat. No. 9,957,732, the handle is mounted to a top end of a shaft, and a shaft cam or a latch pawl is attached to the opposite end of the shaft. When a user rotates the handle, this causes the shaft cam or latch pawl to rotate with the attached shaft in the same direction the handle is rotated. In the design shown in FIGS. 1A and 1B of U.S. Pat. No. 9,957,732, a user must fold the handle down into the body of the compression latch to cause the rod and the attached shaft cam or latch pawl to move linearly with respect to the body of the compression handle. Linear movement of the shaft cam or latch pawl is required to compress the shaft cam or latch pawl to a hatch frame or door frame.

The compression handle described in U.S. Pat. No. 9,957,732 and similar compression handles suffer from at least one shortcoming in that a user of the compression handle is forced to fold and unfold the handle to effect linear movement of the rod and the attached shaft cam or latch pawl. This requires a user of the compression latch to slide their fingers behind the T-handle or D-handle every time they need to latch and unlatch a hatch or a door. This can become cumbersome, particularly for a user with large hands or a user wearing gloves. On fishing vessels, it is common to wear gloves in cold or otherwise inclement weather. When it is snowing, sleeting or the temperature is below freezing, this further exacerbates a user's ability to slide their fingers under a T-handle or D-handle to effect linear motion of the rod to latch or unlatch the compression handle.

Accordingly, there remains a need for improved compression latches that are simple in design, easy to assemble, reliable, low in cost, and provide improved ways to latch and unlatch the compression latch.

### SUMMARY

One or more embodiments of the disclosure are directed to a compression latch comprising a compression latch body comprising a first side and a second side opposite the first side; a handle extending from the first side and rotatable in an x-y plane; a rod extending from the second side in a z direction; a latch pawl connected to the rod; and a linear actuator connected to the handle and the rod, such that rotation of the handle in a first rotational direction within the x-y plane moves the rod in a first linear direction normal to the x-y plane and rotation of the handle in a second rotational direction opposite the first rotational direction moves the rod in a second linear direction opposite the first linear direction.

In a second embodiment, a compression latch comprises a compression latch body comprising a first side and a second side opposite the first side with a transverse hole from the first side to the second side; a handle extending from the first side and rotatable in an x-y plane; a rod extending through the transverse hole to the second side in a direction normal to the x-y plane; a latch pawl connected to the rod, the latch pawl adjustable along the rod; and a linear actuator connected to the handle and the rod, such that rotation of the handle in a first rotational direction within the x-y plane moves the rod in a first linear direction normal to the x-y plane and rotation of the handle in a second rotational direction opposite the first rotational direction moves the rod in a second linear direction opposite the first direction. The linear actuator comprises an engagement member comprising an upper portion extending through the transverse hole to the first side and a lower portion within the compression latch body, the upper portion connected to the handle, the lower portion configured to receive the rod and connected to the rod by a transverse rod, the lower portion comprising a slanted transverse slot to receive the transverse rod; and a fixed sleeve surrounding the lower portion of the engagement member, the fixed sleeve comprising a receiving slot configured to receive the transverse rod. In a third embodiment, linear actuator comprises a transverse rod; an engagement member configured to rotate in an x-y plane, the engagement member configured to receive the transverse rod and connected to the engagement member, the engagement member comprising a transverse slot to receive the transverse rod; and a sleeve fixed in all directions and surrounding at least a portion of the engagement member, the sleeve comprising a receiving slot configured to receive the transverse rod such that rotation of the engagement member in a first rotational direction within an x-y plane moves the transverse rod in a first linear direction normal to the x-y plane and rotation of the engagement member in a second rotational direction opposite the first rotational direction moves the transverse rod in a second linear direction opposite the first direction.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a front isometric view of a compression latch including a latch pawl according to an embodiment of the disclosure;

FIG. 2 is a rear isometric view of the compression latch shown in FIG. 1 without the latch pawl;

FIG. 3 is a cross-sectional view of the compression latch taken along line 3-3 of FIG. 1 without the latch pawl;

FIG. 4 is an exploded assembly view of the compression latch shown in FIG. 1 without the latch pawl;

FIG. 5 is a side view of the handle, the rod and the linear actuator that moves the rod of the compression latch shown in FIG. 2 in a first position prior to the handle being turned;

FIG. 6 is a side view of the handle, the rod and the linear actuator that moves the rod of the compression latch shown in FIG. 5 in a second position after the handle has been turned;

FIG. 7 is a side view of the handle, the rod and the linear actuator that moves the rod of the compression latch shown in FIG. 5 in a third position after the handle has been turned further in the same direction as in FIG. 5;

FIG. 8 is side view of the handle, the rod and the linear actuator that moves the rod of the compression latch shown in FIG. 5 in a fourth position after the handle has been turned further in the same direction as in FIG. 6;

FIG. 9 is a front view of the engagement member of the compression latch shown in FIG. 1;

FIG. 10 is a cross-sectional view of the engagement member taken along line 10-10 of FIG. 9;

FIG. 11 is a isometric view of the engagement member of FIG. 9;

FIG. 12 is a bottom isometric view of the engagement member of FIG. 9,

FIG. 13 is a front view of the fixed sleeve of the compression latch shown in FIG. 1;

FIG. 14 is a cross-sectional view of the fixed sleeve taken along line 14-14 of FIG. 13;

FIG. 15 is a side view of the fixed sleeve of FIG. 13;

FIG. 16 is an isometric view of the fixed sleeve of FIG. 13; and

FIG. 17 is an alternate embodiment of a latch pawl that is mountable to the compression latch shown in FIG. 1.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

The term “horizontal” as used herein is defined as a plane parallel to the plane or surface of a compression latch, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures.

The term “on” indicates that there is direct contact between elements. The term “directly on” indicates that there is direct contact between elements with no intervening elements.

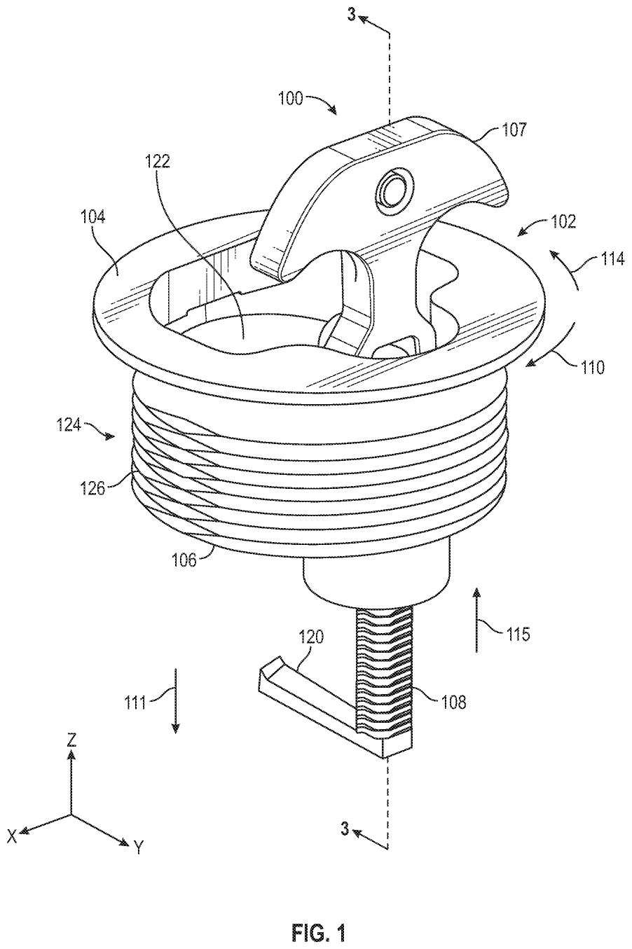

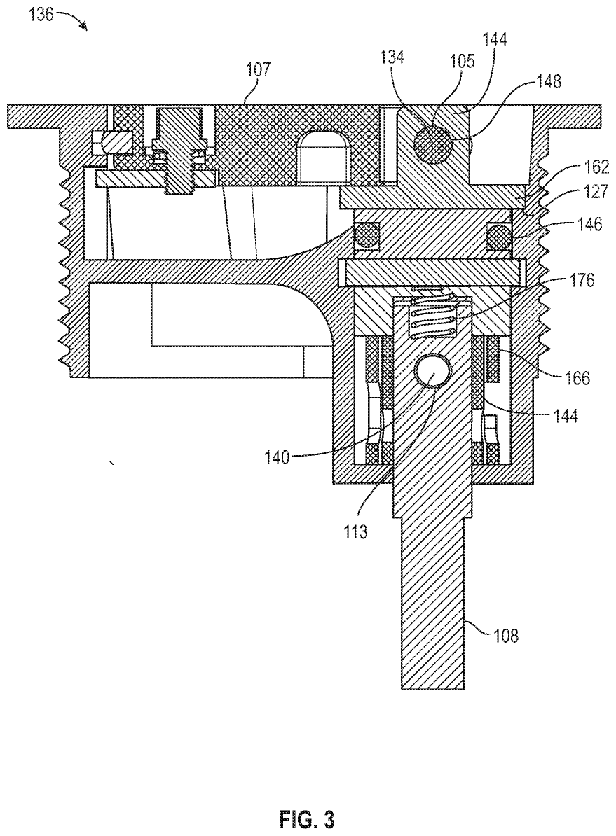

Referring now to FIGS. 1-16, an embodiment of a compression latch 100 is shown. The compression latch 100 as shown comprises a compression latch body 102 having a first side 104 and a second side 106 opposite the first side 104. The compression latch 100 further comprises a handle 107 that extends from the first side 104 and is rotatable in an x-y plane. The compression latch 100 further comprises a rod 108 that extends through the first side 104 to the second side 106 in the z-direction and a linear actuator 112 (see FIGS. 3-8) that is connected to the handle 107 and the rod 108, such that rotation of the handle 107 in a first rotational direction 110 within the x-y plane moves the rod 108 in a first linear direction 111 normal to the x-y plane. Rotation of the handle 107 in a second rotational direction 114, opposite the first rotational direction 110, moves the rod 108 in a second linear direction 115, opposite the first linear direction 111.

The compression latch 100 according to one or more embodiments further comprises a latch pawl 120 connected to the rod 108. In the embodiment shown, the latch pawl 120 is connected to the rod 108 on an end of the rod opposite the end that the handle 107 is connected to the rod 108. In the embodiment shown, the rod 108 is threaded, and in some embodiments, the latch pawl 120 can be affixed to the rod by a nut and washer (not shown).

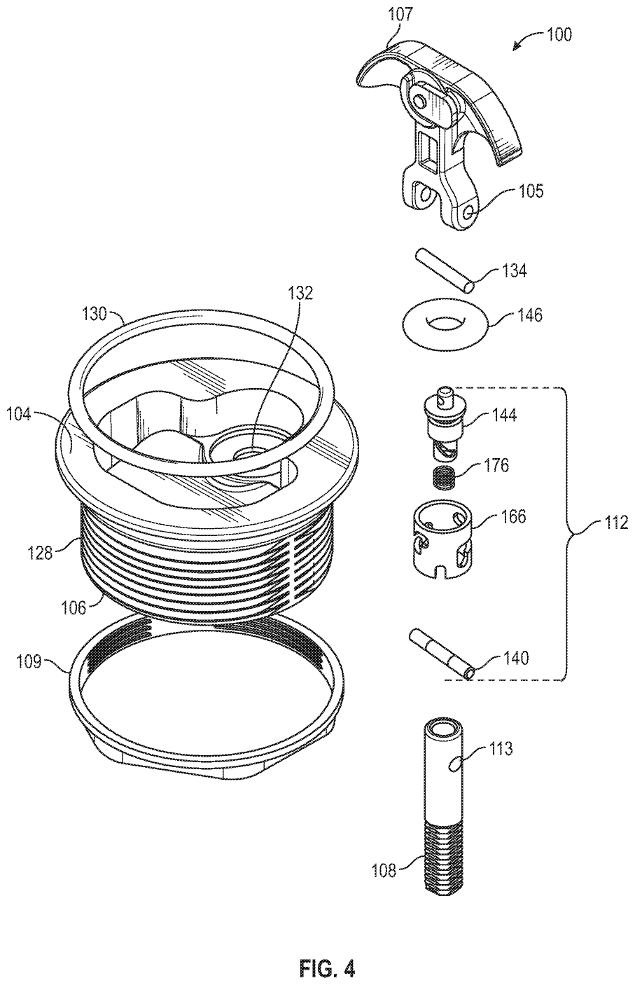

In the embodiment shown, the compression latch body 102 further comprises of a recessed portion 122 on the first side 104. The compression latch body 102 further comprises a side wall 124 extending between the first side and the second side 106. The side wall 124 comprises a plurality of threads 126 that can engage a body fastener 109, for example a threaded nut 109 as shown in FIG. 4. The compression latch 100 may further comprise a body seal 130, which may be in the form of an elastomeric O-ring, which provides a water tight seal when the body fastener 109 is threadably engaged with the plurality of threads 126.

Referring now to FIG. 4, the compression latch body 102 further comprises of a transverse hole 132 extending from the first side 104 side to the second side 106 through which the rod 108 is inserted. A linear actuator 112 connects the handle 107 to the rod 108 via a transverse handle pin 134, which extends through a handle pin opening 105 in the handle 107 and a transverse rod 140, which extends through a rod hole 113 in the rod 108.

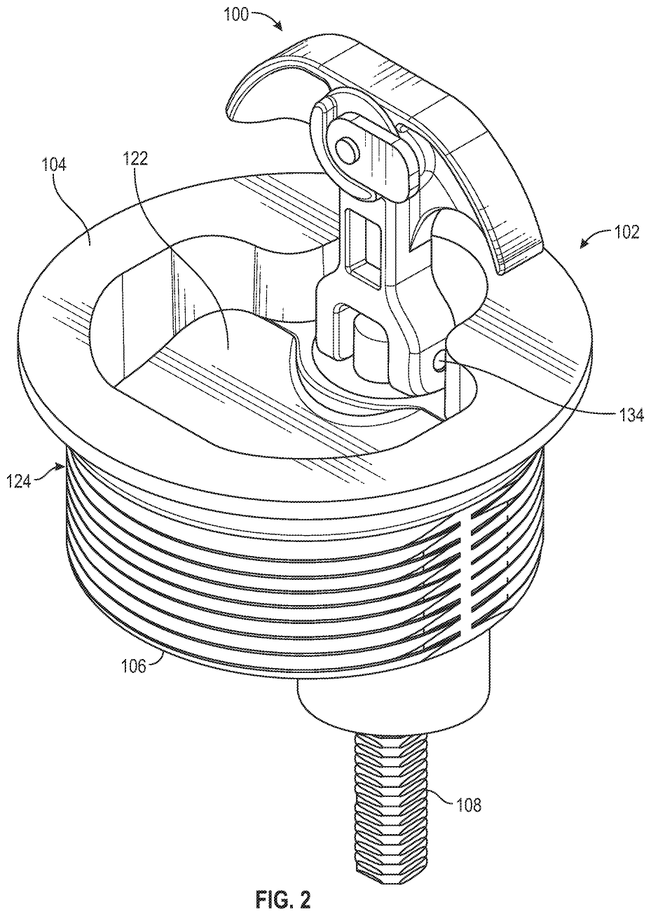

The handle 107 is foldable from a folded position as shown in FIG. 3 to an extended position as shown in FIGS. 1 and 2 along an axis defined by the rod 108. The handle 107 cannot be rotated by a user when the handle 107 is in the folded position shown in FIG. 3, thus preventing a user from utilizing the linear actuator 112. The handle 107 is shaped to fit within the recessed portion 122 of the compression latch body 102 while in the folded position. When the handle 107 is in the folded position, the handle 107 fits in the recessed portion 122 and is flush with the first side 104 of the compression latch body 102.

The latch pawl 120 may comprise different shapes to latch to the appropriately sized door frame of hatch frame. For example, a latch pawl 120 in an L-shaped configuration may be utilized for door frames that have greater depths or thicknesses.

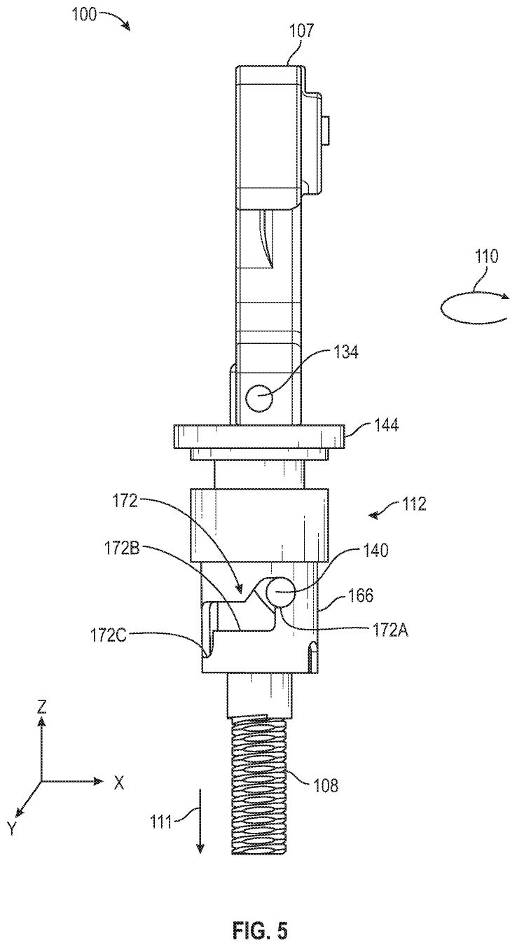

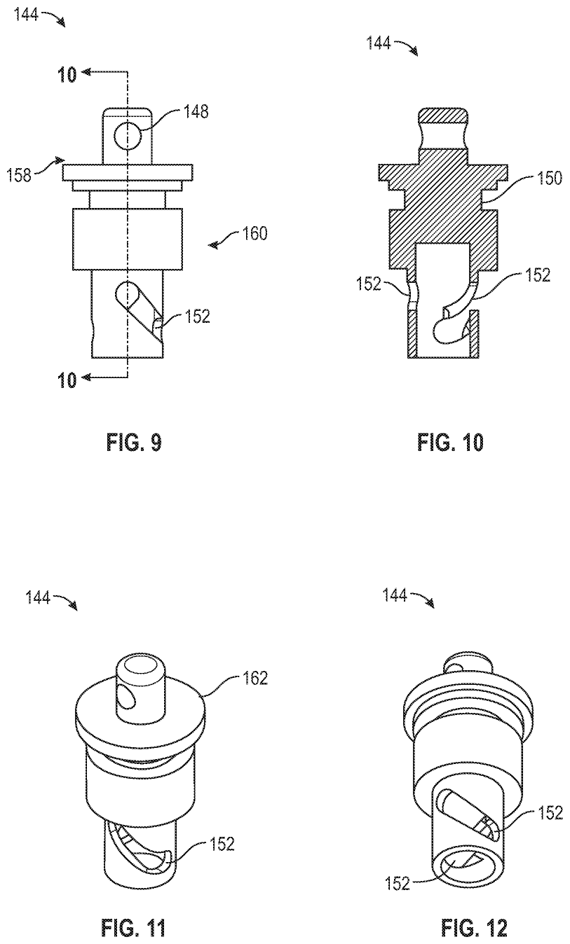

Referring again to FIGS. 4 and 5, the linear actuator 112 comprises an engagement member 144, which in the embodiment shown is cylindrical in shape. FIGS. 9-12 show details of the engagement member 144. As shown in FIG. 3, the engagement member 144 is positioned inside the compression latch body 102. As best shown in FIGS. 9-12, the engagement member 144 comprises of a top portion 158 and a bottom portion 160. Within the top portion 158, there is a handle pin receiving hole 148 through which the transverse handle pin 134 is inserted to connect the engagement member 144 to the handle 107.

As best shown in FIGS. 4 and 5, the transverse handle pin 134 also is inserted through the handle pin opening 105 in the handle 107 to connect the handle 107 to the engagement member 144. Below the handle pin receiving hole 148 is a peripheral ledge 162 that rests on a surface of the compression latch body 102 as shown in FIG. 3. A groove 150 beneath the peripheral ledge 162 of the engagement member 144 provides a recess to hold a linear actuator seal 146 when in the linear actuator 112 is positioned inside the compression latch body 102. The bottom portion 160 of the engagement member comprises at least a first transverse slot 152. In the embodiment shown, the bottom portion 160 of the engagement member 144 comprises two transverse slots 152. The transverse slots 152 are slanted upwards towards the top portion 158 of the engagement member 144. The transverse slots 152 are sized to that the transverse rod 140 is able to glide up and down the transverse slots 152 as the handle 107 is rotated.

Within the compression latch body 102, the top portion 158 of the engagement member 144 extends through a first end 127 of the transverse hole 132 to the first side 104 of the compression latch body 102, and the rod 108 extends through a second end of a transverse hole 132 to the second side 106 of the compression latch body 102.

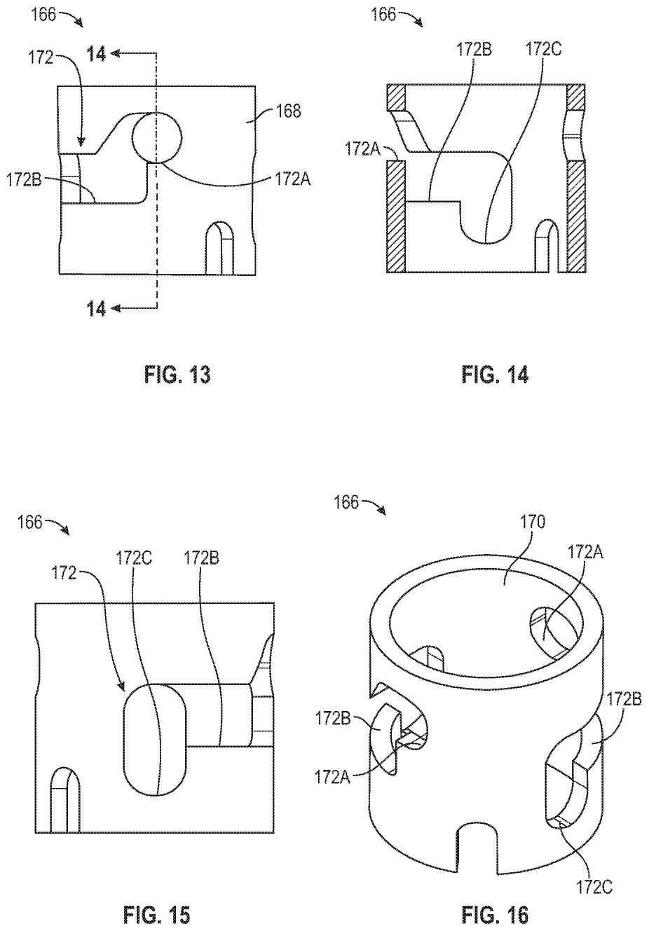

The linear actuator 112 further comprises of a sleeve 166 shown in FIGS. 13-16 that has a cylindrical shape with a hollow inner portion 170. The sleeve 166 comprises a solid side wall 168 except for at least one receiving slot 172 in the side wall 168 of the sleeve 166. The sleeve 166 in one or more embodiments is a fixed sleeve which does not move during operation of the compression latch. In the embodiment shown, there are two receiving slots 172. The receiving slots 172 are configured as a Z-shaped slot comprising an upper portion 172a, a middle portion 172b which is generally horizontal and a lower portion 172c. It will be understood that the receiving slot 172 is not limited to the shape shown.

Referring back to FIG. 3, the linear actuator 112 fits concentrically over the engagement member 144 positioned within the compression latch body 102. When fitted together, the receiving slots 172 align with the slanted transverse slot 152 of the engagement member 144, thus allowing the transverse rod 140 to pass through both the receiving slots 172 and the transverse slot 152. The sleeve 166 is fitted over the engagement member 144, and the engagement member 144 rotates in the first rotational direction 110 within the sleeve 166, which is within compression latch body 102.

As will be appreciated, in the embodiment shown, the linear actuator 112, comprises the sleeve 166, the engagement member 144 fitted within the sleeve 166 and the transverse rod 140 that is under compression via the spring 176. The transverse rod 140 connects and engaged the sleeve 166, the engagement member 144 and the rod 108.

FIGS. 5-8 show operation of the compression handle in which the linear actuator 112 causes the rod 108 to move linearly in the first linear direction 111 by rotating the handle in the first rotational direction 110. The receiving slot comprising the upper portion 172a, the middle portion 172b and the lower portion 172c provide a guide track that permits transverse rod 140 to move linearly from the upper portion 172a to the middle portion 172b and the lower portion 172c when the handle 107 is rotated in first rotational direction 110.

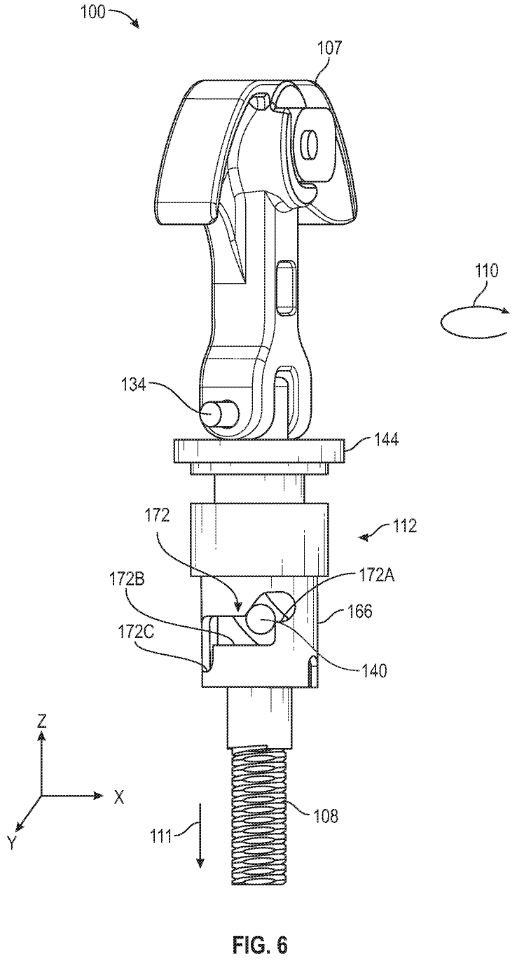

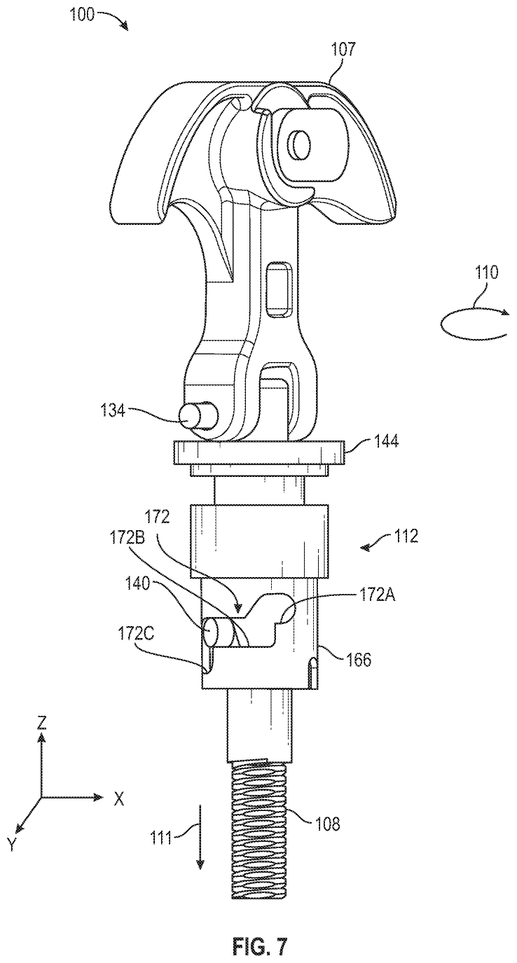

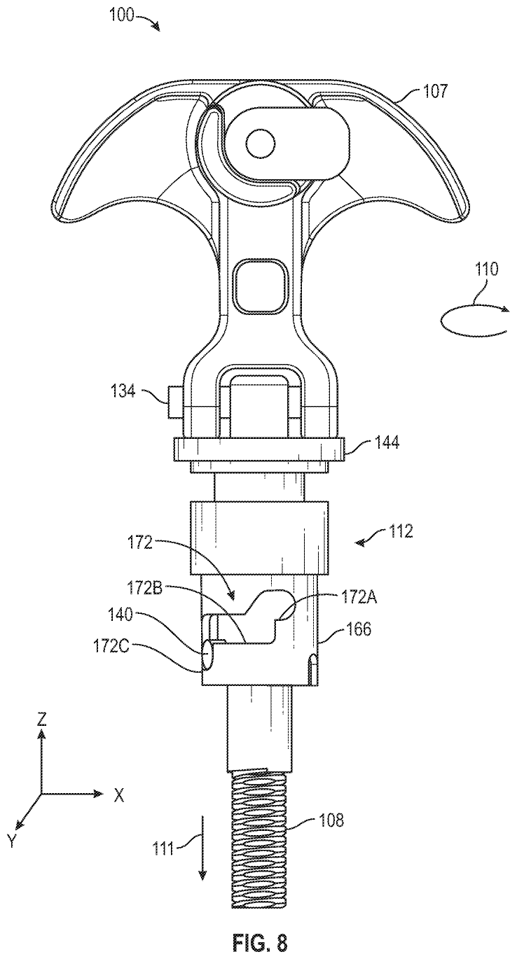

As shown in FIG. 5, the handle 107 is in a first position and the transverse rod 140 is located in the upper portion 172a of the receiving slot 172. In FIG. 6, the handle has been rotated in first rotational direction 110, causing the transverse rod 140 to move to the middle portion 172b of the receiving slot 172 as the engagement member 144 has been rotated in the first rotation direction 110. This movement causes the rod 108 to move in first linear direction 111. In FIG. 7, the handle 107 has been further rotated in first rotational direction 110, causing the engagement member 144 and transverse rod 140 to also rotate in the first rotational direction 110. The transverse rod 140 has moved to the position where it will next move to the lower portion 172c of the receiving slot 172. In FIG. 8, further rotation of the handle 107 in the first rotational direction 110 causes the engagement member 144 and transverse rod 140 to also rotate in the first rotational direction 110. The transverse rod has now moved into the lower portion 172c of the receiving slot 172, causing linear motion of the engagement member 144 and the rod 108. During this operation, the transverse rod 140 moves through the receiving slot 172 from the upper portion 172a, to the middle portion 172b and the lower portion 172c A spring 176 is provided within the sleeve 166, and there is a force exerted on transverse rod 140 with the spring 176 to assist the transverse rod 140 to move through both the receiving slot 172 and the transverse slot 152. The transverse slot 152 is positioned at an angle with respect to the longitudinal axis of the rod 108 and the engagement member.

Locking and unlocking of the compression latch 100 is operated by the rotation of the handle 107. The clockwise rotation of the handle 107 in the first rotational direction causes the linear actuator 112 to translate the rod 108 and the latch pawl 120 in the z-direction away from the first side 104 of the compression latch body 102, thus releasing the compression latch 100 to a frame of a hatch door and allowing the door to open. As the handle 107 is rotated in the counter-clockwise direction in second rotational direction 114, the linear actuator 112 translates the rod 108 and the latch pawl 120 in the z-direction towards the first side 104 of the compression latch body 102, thus applying the compression latch to a frame of a door hatch making it closed shut. As will be appreciated, the linear actuator 112 components function similar to a worm gear so that rotational motion of the handle to causes translational or linear motion of the rod 108 linked to the handle.

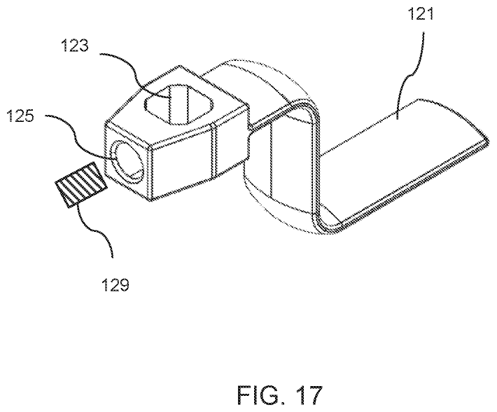

In some embodiments, the latch pawl 120 contains a threaded opening so that the latch pawl 120 can be rotated onto the threaded portion of rod 108. Alternatively, as discussed above, the latch pawl 120 can be slidably mounted to the rod 108 and held in place with a nut and an optional lock washer. FIG. 17 shows an alternate embodiment of a latch pawl 121 that is mountable to the rod 108 of the compression latch shown in FIGS. 1-8. The latch pawl 121 in FIG. 17 has a rod opening 123 that is polygonal in shape, e.g., square, rectangular, hexagonal, and the like. In embodiments that use the latch pawl 121 shown in FIG. 17, the rod 108 would have a complementary cross-sectional shape so that when the latch pawl 121 is mounted on the rod, the latch pawl 121 does not rotate with respect to the rod. A set screw opening 125 is sized to receive a set screw 129 as shown in FIG. 17. For the compression latch 100 shown with respect to FIGS. 1-8, the latch pawl 121 shown has an advantage of providing more flexibility in mounting the latch pawl 121 using the set screw 129. By sliding the latch pawl 121 linearly along the rod 108, once the optimum position of the latch pawl has been determined so that the compression latch provides an acceptably tight closure of a door or latch, the set screw 129 can be engaged through the set screw opening 125 to engage and lock the latch pawl 121 in the desired position on the rod 108. The set screw 129 can be loosened and the position of the latch pawl 121 can be adjusted and readjusted on the rod 108.

Although embodiments of the present disclosure have been described in detail hereinabove in connection with certain exemplary embodiments, it should be understood that the disclosure is not limited to the disclosed exemplary embodiments, but, on the contrary is intended to cover various modifications and/or equivalent arrangements included within the spirit and scope of the present disclosure.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

What is claimed is:

1. A compression latch comprising:
a compression latch body comprising a first side and a second side opposite the first side;
a handle extending from the first side and rotatable in an x-y plane;
a rod extending from the second side in a z direction;
a latch pawl connected to the rod; and
a linear actuator connected to the handle and the rod, such that rotation of the handle in a first rotational direction within the x-y plane moves the rod in a first linear direction normal to the x-y plane and rotation of the handle in a second rotational direction opposite the first rotational direction moves the rod in a second linear direction opposite the first linear direction.

2. The compression latch of claim 1, wherein the compression latch body comprises a recessed portion on the first side.

3. The compression latch of claim 1, wherein the compression latch body comprises a transverse hole from the first side to the second side.

4. The compression latch of claim 1, wherein the handle is connected to the linear actuator by a transverse handle pin.

5. The compression latch of claim 4, wherein the handle is foldable from a folded position to an extended position along an axis defined by the transverse handle pin.

6. The compression latch of claim 5, wherein the handle is unable to rotate while in the folded position.

7. The compression latch of claim 5, wherein the compression latch body comprises a recessed portion on the first side, and the handle is shaped to fit within the recessed portion of the compression latch body while in the folded position.

8. The compression latch of claim 1, wherein the rod is connected to the linear actuator by a transverse rod.

9. The compression latch of claim 1, wherein the latch pawl is adjustable along the rod.

10. The compression latch of claim 1, wherein the linear actuator comprises an engagement member comprising a top portion connected to the handle.

11. The compression latch of claim 10, wherein the top portion of the engagement member is connected to the handle by a transverse handle pin.

12. The compression latch of claim 10, wherein the engagement member comprises a bottom portion configured to receive the rod, the bottom portion comprising a slanted transverse slot to receive a transverse rod.

13. The compression latch of claim 12, wherein the bottom portion of the engagement member is positioned within the compression latch body.

14. The compression latch of claim 13, wherein the top portion of the engagement member extends through a first end of a transverse hole to the first side of the compression latch body and the rod extends through a second end of a transverse hole to the second side of the compression latch body.

15. The compression latch of claim 12, wherein the linear actuator comprises a fixed sleeve surrounding the bottom portion of the engagement member, the fixed sleeve comprising a receiving slot configured to receive the transverse rod.

16. The compression latch of claim 15, wherein the receiving slot comprises an upper portion, a middle portion and the lower portion configured to provide a guide for the transverse rod during rotation of the handle in the x-y plane.

17. A compression latch comprising:
a compression latch body comprising a first side and a second side opposite the first side with a transverse hole from the first side to the second side;
a handle extending from the first side and rotatable in an x-y plane;
a rod extending through the transverse hole to the second side in a direction normal to the x-y plane;
a latch pawl connected to the rod, the latch pawl adjustable along the rod; and
a linear actuator connected to the handle and the rod, such that rotation of the handle in a first rotational direction within the x-y plane moves the rod in a first linear direction normal to the x-y plane and rotation of the handle in a second rotational direction opposite the first rotational direction moves the rod in a second linear direction opposite the first linear direction, the linear actuator comprising:
an engagement member comprising an upper portion extending through the transverse hole to the first side and a lower portion within the compression latch body, the upper portion connected to the handle, the lower portion configured to receive the rod and connected to the rod by a transverse rod, the lower portion comprising a slanted transverse slot to receive the transverse rod; and
a fixed sleeve surrounding the lower portion of the engagement member, the fixed sleeve comprising a receiving slot configured to receive the transverse rod.

18. The compression latch of claim 17, wherein the compression latch body further comprises a recessed portion on the first side, the handle is shaped to fit within the recessed portion, the handle is connected to the engagement member by a transverse handle pin, the transverse handle pin defines an axis about which the handle may fold from an extended position from the compression latch body to a folded position within the recessed portion of the compression latch body, the handle unable to rotate while in the folded position.

19. The compression latch of claim 17, wherein the receiving slot comprises an upper portion, a middle portion and a lower portion configured to provide a guide for the transverse rod during rotation of the handle in the x-y plane.

20. A linear actuator comprising:
a transverse rod;
an engagement member configured to rotate in an x-y plane, the engagement member configured to receive the transverse rod and connected to the engagement member, the engagement member comprising a transverse slot to receive the transverse rod; and
a sleeve fixed in all directions and surrounding at least a portion of the engagement member, the sleeve comprising a receiving slot configured to receive the transverse rod such that rotation of the engagement member in a first rotational direction within an x-y plane moves the transverse rod in a first linear direction normal to the x-y plane and rotation of the engagement member in a second rotational direction opposite the first rotational direction moves the transverse rod in a second linear direction opposite the first linear direction.
